(19) United States
(12) Patent Application Publication
(10) Pub. No.: US 2018/0324013 A1
(43) Pub. Date: Nov. 8, 2018

(54) PHASE INTERPOLATION CALIBRATION FOR TIMING RECOVERY

(71) Applicant: MACOM Technology Solutions Holding, Inc., Lowell, MA (US)

(72) Inventors: Yehuda AZENKOT, San Jose, CA (US); Bart R. ZEYDEL, El Dorado Hills, CA (US)

(21) Appl. No.: 15/584,989

(22) Filed: May 2, 2017

(51) Int. Cl. H04L 27/233; H04L 1/00

(52) U.S. Cl. CPC H04L 27/2334; H04L 1/0016; H04L 27/2331

(57) ABSTRACT

System and method of timing recovery using calibration logic to correct non-idealities related to phase interpolation. The calibration logic includes a Look-Up Table (LUT) preloaded with a set of expected output phases of the interpolator. During operation, an input phase signal is quantized and supplied to the calibration logic. In response, the LUT outputs a subset of preloaded values that are closest to the quantized phase signal. Each preloaded value in the subset is compared with the input phase signal to identify the one that is closest to the input phase signal. The index of the identified preloaded value is used to correct the input phase signal. Thus, the input to the phase interpolator is calibrated based on a preloaded value that is closest to the input phase signal which is regarded as the desired phase shift to be achieved by the phase interpolator.

### TECHNICAL FIELD

The present disclosure relates generally to the field of signal processing in communications and, more specifically, to the field of phase interpolation in signal processing.

### BACKGROUND OF THE INVENTION

In communications systems, a transmitter sends data streams to a receiver in symbols, such as bits of data. As the receiver clock is typically not synchronized with the transmitted clock, the receives needs to correctly recover the clock from the receiving signal itself. In addition, when data is transmitted over a communication channel, it is usually distorted in terms of phase and amplitude due to various types of noise, such as fading, oscillator drift, frequency and phase offset, and receiver thermal noise. At the receiver, the system is also subject to noise and timing jitter in a time domain. Therefore, the receiver needs a timing recovery process to obtain symbol synchronization, particularly to correct the clock delay and derive the optimal clock phase that is used to sample the received signal and achieve the best Signal-to-Noise Ratio (SNR).

Interpolator-based timing recovery, as opposed to Voltage-Controlled Oscillator (VCO)-based, offers high portability and scalability across different signal process technologies. It also allows the sharing of phase-locked loop (PLL) circuits across multiple lanes which provides high efficiency use of power and chip area. FIG. 1 illustrates the configuration of an interpolator-based timing recovery loop 100 in accordance with the prior art. The timing recovery loop 100 is configured to output a recovered clock 103 responsive to a received digital signal 101 and based on a reference clock 102.

More specifically, the timing recovery loop includes a phase detector 110, a loop filter 120, a quantizer 130 and the phase interpolator 140. During operation, the phase detector 110 can detect a phase difference between the received signal 101 and the recovered block 103 fed back from the output of the timing recovery loop 100. The loop filter 120 filters the detected phase difference and forwards it to the quantizer 130. The quantizer 130 quantizes the output of the loop filter 130 to, e.g., 8 bits, to generate an input to the phase interpolator 140. In response to this input being directly sent from the quantizer and based on the reference clock 102, the phase interpolator 140 generates finely phase shifted version of the recovered clock 103.

A phase interpolator or phase rotator can be implemented based on interpolation between two phases, in-phase (I) and quadrature-phase (Q) of the reference clock. A pair of variable gain amplifiers (VGA) are used to set the relative weights of the I and Q components separately. The I and Q components are then combined to yield the desired signal. An ideal phase interpolation process generates a phase constellation including a number of equally-spaced phase positions for a full circle from 0 to 2π. This process can be represented as:

y=I·cos(ωt)+Q·sin(ωt)

I=cos(x)

Q=sin(x)

y=\sqrt{I²+Q²}·cos(ωt+arctan(Q/I))

wherein x and y represents the input and output of the phase interpolator, respectively; and ω represents the frequency of the reference clock. The output phase, which is given by arctan(Q/I), is thus equal to the input phase x which is the phase shaft to be achieved by the phase interpolator.

Due to the difficulties in implementing the sine and cosine functions, phase interpolators commonly use some form of approximation for the circular phase constellation, such as linear or square approximation, octagonal approximation, etc.

As demanded by increasingly high data rates, modulations with high constellations have become necessary in high speed communication systems. Using higher constellations requires timing recovery or Clock Data Recovery (CDR) with lower phase jitter, which requires the use of high performance phase interpolators. However, it has been recognized that there are various non-ideally sources in a timing recovery loop that tend to cause errors in phase interpolation which impair the performance of a phase interpolator.

For example, both amplitude and phase mismatches are inevitable for quadrature generation circuits, especially during wideband operations. Also, quantization errors are nearly unavoidable. Even when the timing recovery loop is in a locked state, jitter at the edges of the input data (i.e., quantization error) generally causes the phase detector to output early and late signals which are, in effect, randomly distributed. As a result, the recovered clock signal will generally include highly random dither jitter. In other words, the phase of the recovered clock at the output of the phase interpolator typically shuts up and down, dithering between two adjacent phases. Further, the relatively long latency of the timing recovery loop may make the recovered clock dither more than plus or minus one phase step of the phase interpolator, thereby aggravating the sampling phase errors.

### SUMMARY OF THE INVENTION

Accordingly, disclosed herein provide a mechanism to overcome the non-idealities pertinent to operations and performance of a phase interpolator and thereby reduce timing recovery jitter in a timing recovery process.

Embodiments of the present disclosure employ calibration logic to correct the deterministic non-idealities related to phase interpolation and generate a calibrated input phase signal to a phase interpolator in a timing recovery loop. The calibration logic includes a Look-Up Table (LUT) preloaded with a set of expected output phases of the phase interpolator. These expected output phases may result from a prior simulation process and, for instance, correspond to the equally-spaced phase positions in a square phase constellation. During operation, an input phase signal (e.g., a detected phase difference that is filtered by a loop filter) is quantized and supplied to the calibration logic. In response, the LUT outputs a subset of preloaded values that are closest to the quantized phase signal. Each of the preloaded values in the subset is then compared with the input phase signal to identify the preloaded value that is closest to the input phase signal. The identified preloaded value is then supplied as a calibrated input phase signal to the phase interpolator for generating the recovered clocks signal. In some other embodiments, the LUT may be preloaded with phase errors between quantized phase signals and expected output from the phase interpolator.

Therefore, according to embodiments of the present disclosure, the quantized phase input to the phase interpolator is calibrated and substituted with an expected phase output of the phase interpolator that is closest to the input phase signal which is regarded as the desired phase shift to be achieved by the phase interpolator. As the preloaded values are predetermined by taking into account the deterministic non-idealities related to phase interpolation in the timing recovery loop, the calibration process can advantageously compensate for these non-idealities by using a preloaded value (or a derivative thereof) as an input to the phase interpolator. Thereby, the output of phase interpolator is closer to the desired phase shift, compared with the conventional art without using calibration. As a result, timing recovery can be advantageously and effectively reduce.

According to one embodiment of the present disclosure, a method of signal processing include: receiving an input phase signal representing a first phase; quantizing the input phase signal into a quantized phase signal; based on the quantized phase signal, selecting a subset of predetermined values from a set of predetermined values; identifying a matching predetermined value from the subset of predetermined values; generating a calibrated input phase signal based on the matching predetermined value; and performing phase interpolation based on the calibrated input phase signal.

According to another embodiment of the present disclosure, a device includes: a quantizer configured to generate a quantized phase signal responsive to an input phase signal; a phase interpolator; and calibration logic coupled to the quantizer and the phase interpolator. The calibration logic is configured to output a corrected input phase signal to the phase interpolator responsive to the quantized phase signal. The calibration logic includes: a Look-Up Table (LUT) storing a set of predetermined values; and logic configured to (1) identify a matching predetermined value from the set of predetermined values based on the input phase signal and (2) generate the corrected input phase signal based on the matching predetermined value.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. Although a method may be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the invention are semi-diagrammatic and not to scale, and particularly, some of the dimension are for the clarity of presentation and are shown exaggerated in the Figures. Similarly, although the views in the drawings for the ease of description generally show similar orientations, this depiction in the Figures is arbitrary for the most part. Generally, the invention can be operated in any orientation.

### BRIEF DESCRIPTION OF THE DRAWINGS

Embodiments of the present invention will be better understood from a reading of the following detailed description, taken in conjunction with the accompanying figures, in which like reference characters designate like elements.

FIG. 1 illustrates the configuration of an interpolator-based timing recovery loop 100 in accordance with the prior art.

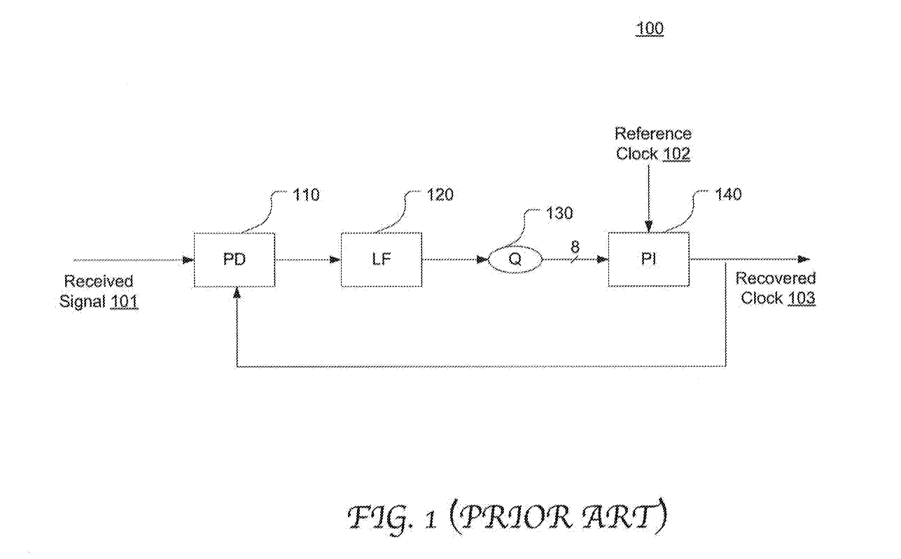

FIG. 2 illustrates the configuration of an exemplary interpolator-based timing recovery loop that includes calibration logic for the phase interpolator in accordance with an embodiment of the present disclosure.

FIG. 3 illustrates the configuration of exemplary calibration logic having an LUT in accordance with an embodiment of the present disclosure.

FIG. 4 illustrates the configuration of exemplary calibration logic having an LUT in accordance with another embodiment of the present disclosure.

FIG. 5 illustrates an exemplary process of timing recovery including calibration of phase interpolation input in accordance with an embodiment of the present disclosure.

FIG. 6 illustrates an exemplary process of calibrating phase interpolation input in accordance with an embodiment of the present disclosure.

### PHASE INTERPOLATION CALIBRATION FOR TIMING RECOVERY

Overall, embodiments of the present disclosure provide a calibration mechanism for calibrating the input to a phase interpolator (or “PI” herein) such that the phase interpolator can achieve a desired phase shift with enhanced accuracy and precision. The phase interpolator is coupled to calibration logic configured to select from a Look-Up Table (LUT) an expected output value of the phase interpolator that is closest to ail input phase signal, where the input phase signal corresponds to the desired phase shift. The selected value is then supplied to the phase interpolator as a corrected input phase signal.

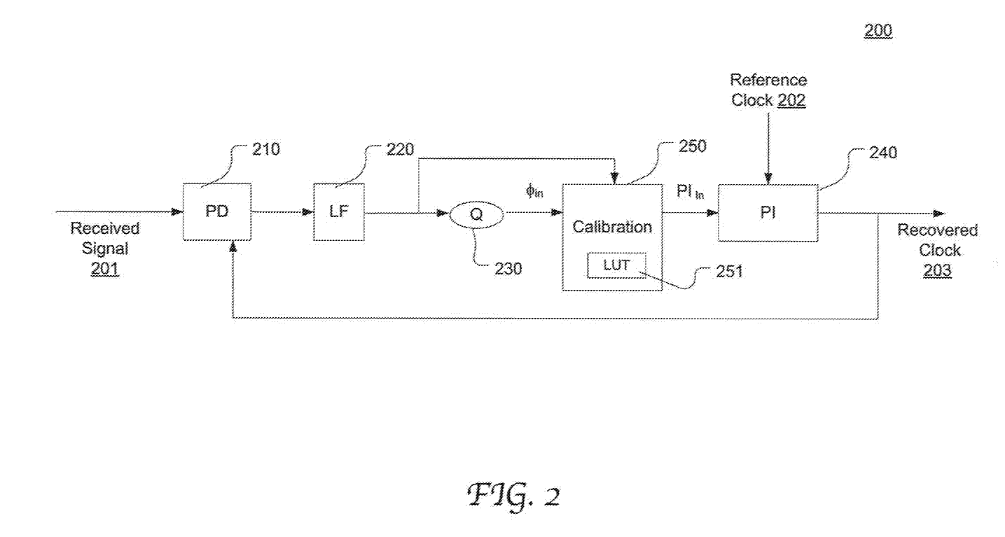

FIG. 2 illustrates the configuration of an exemplary interpolator-based timing recovery loop 200 that includes calibration logic 250 for the phase interpolator 240 in accordance with an embodiment of the present disclosure. The timing recovery loop 200 is configured to output a recovered clock 203 responsive to a received digital signal 201 and based on a reference clock 202. The timing recovery loop additionally includes a phase detector 210, a loop filter 220, a quantizer 220, calibration 250. The timing recovery loop may also include various other components that are well known in the art.

During operation, the phase detector 210 can detect a phase difference between the received signal 201 and the recovered block 203 fed back from the output of the timing recovery loop 200. The loop filter 220 filters the detected phase difference and forwards it (ϕᵢₙ) to the quantizer 230. The quantizer 230 quantizes the output of the loop filter 220 (ϕᵢₙ) based on the resolution of the phase interpolator 240 (e.g., 8 bits) to generate a quantized phase signal (ϕ_{—qin}).

According to the present disclosure, the calibration logic receives the quantized phase signal (ϕ_{—qin}) and, in response, generates a calibrated phase input signal (“PIᵢₙ”) as an input to the phase interpolator. More specifically,. the calibration logic 250 includes a LUT 251 preloaded with a set of expected phase outputs of the phase interpolator 240. For example, the set of expected phase outputs correspond to a full set of equally-spaced phase positions in the phase constellation, e.g., square or octagonal phase constellation depending on the specific configuration of the phase interpolator 240. The set of expected phase outputs may be obtained by using a simulation process which incorporates a broad range of predictable and deterministic errors related to phase interpolation in this timing recovery loop 200. Thus, the expected phase outputs correspond to the phase positions with various predictable non-idealities in the timing recovery loop 200 having been compensated for.

For instance, given the received signal 201, the output (ϕ_{—qin}) of the quantizer 230 ideally should be one of the phase positions in the phase constellation. However, non-ideality behaviors are inevitable in the timing recovery loop 200, which may be caused by specific implementations or non-linearity of the phase interpolator or other issues. As a consequence, the output (ϕ_{—qin}) of the quantizer 230 may instead be located between phase positions in the phase constellation, and so undesirably deviates from the desired phase shift as indicated by the input phase signal (ϕᵢₙ). According to the present disclosure, instead of inputting the output (ϕ_{—qin}) of the quantizer 230 directly to the phase interpolator 240, an expected phase output that is closest to the input phase signal (ϕᵢₙ) is identified by using the LUT 251 and supplied as the input of the phase interpolator 240.

As a result, the phase interpolator 240 can advantageously generate finely phase shifted version of the recovered clock 203 with reduced deviation from the desired phase shift. Accordingly, the timing recovery jitter can be advantageously reduced.

It will be appreciated that the present disclosure is not limited to any specific type of values preloaded in the LUT of the calibration logic, nor limited to any mechanism or process to determine these preloaded values. The calibration logic and the components thereof can be implemented in any suitable configuration or in any suitable manner that is well known in the art.

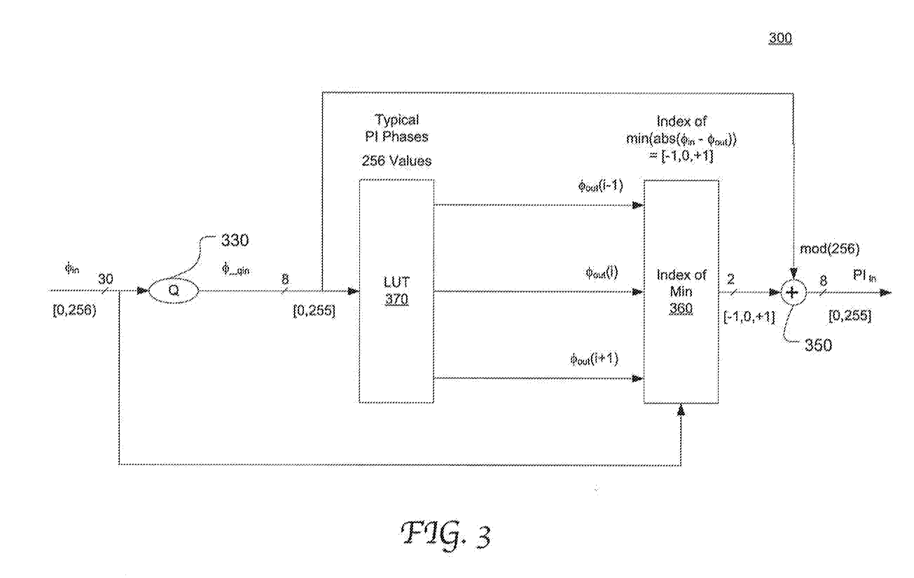

FIG. 3 illustrates the configuration of exemplary calibration logic 300 having an LUT 370 in accordance with an embodiment of the present disclosure. As illustrated, the calibration logic includes an LUT 370 coupled to the quantizer 330, selection logic 360 and an adder 350. The LUT 370 stores the preloaded values of expected phase outputs of the phase interpolator (e.g., phase interpolator 240 in FIG. 2). An LUT according to the present disclosure can be implemented in any configuration or in any manner that is well known in the art.

The LF output (the input phase signal ϕᵢₙ) is the phase that the timing recovery loop desires to set the PI output and may have a different bit width than the resolution of the phase interpolator. As required by the PI input (PI_{In}), the quantizer 330 quantizes the LF output (ϕᵢₙ), e.g., from 30-bit to 8-bit. As the expected non-linearity behavior of the PI can be predicted (e.g., through simulation or nominal specification), it can be used to correct the PIᵢₙ signal and set it closer to the desired input phase (ϕᵢₙ).

Usually the deviations of the actual phase interpolation from the ideal phase interpolation are small, so the phase interpolator input (PI_{In}) can be corrected slightly relative to the input ϕ_qᵢₙ. Typically, the corrected input is within ±1 step relative to the input ϕ_{—qin}. Thus, in some embodiments, the expected PI outputs (stored in the LUT) for 3 possible inputs are compared to the input ϕᵢₙ and the closest one out of the 3 is selected. However, it will be appreciated that this discussion is merely exemplary. It will be appreciated that any number of possible preloaded values can be output from the LUT for comparison with the input phase signal (ϕᵢₙ) without departing from the scope of the present disclosure. The input ϕ_{—qin} is then corrected accordingly by adding 0, 1 or −1, so the selected expected PI output is closer to the input ϕᵢₙ.

More specifically, the lookup table (LUT) is preloaded with 256 phase values of typical PI outputs, where each phase corresponds to a different input to the phase interpolator in value. In response to the quantized input (ϕ_{—qin}), the LUT selects 3 expected PI output phases that are stored therein. These 3 expected PI phases (ϕₒᵤₜ(i−1), ϕₒᵤₜ(i) and ϕₒᵤₜ(i+1)) are the PI output expected phases for the PIᵢₙ values being ϕ_qᵢₙ, ϕ_{qin}−1, and ϕ_{—qin}+1. The desired setting of PI input phase (PIᵢₙ) is the one (out of the 3 possibilities or candidates) that expected to generate a PI output phase that is the closest to the desired input phase (ϕᵢₙ). As noted above, due to the non-idealities, the ϕ_{—qin} or the ϕₒᵤₜ(i) may not necessarily be the closest one to the desired input phase (ϕᵢₙ) among the 3 possibilities.

The selection logic 360 can identify the index of the closest expected PI phase by comparing, the 3 expected PI phases (ϕₒᵤₜ(i−1), ϕₒᵤₜ(i) and ϕₒᵤₜ(i+1)) with the desired input phase (ϕᵢₙ). The minimum operation of the selection logic 360 can be represented as:

$$index = {min}_{k = - 1 , 0 , + 1} \{ abs ( {φ}_{in} - {φ}_{out} ( i - k ) ) \}$$

Thus, the selection logic 360 identifies the index (−1, 0 or +1) of the expected PI phase that results in the minimum difference from the desired input phase (ϕᵢₙ). The PIᵢₙ signal is then obtained by using the adder 350 to add the index obtained by the minimum operation (−1, 0 or +1) to ϕ_{—qin}. The adder operation is modulo 256, where the PIᵢₙ range is from 0 to 255. For example, mod(2+1)=3 and mod(255+1)=0.

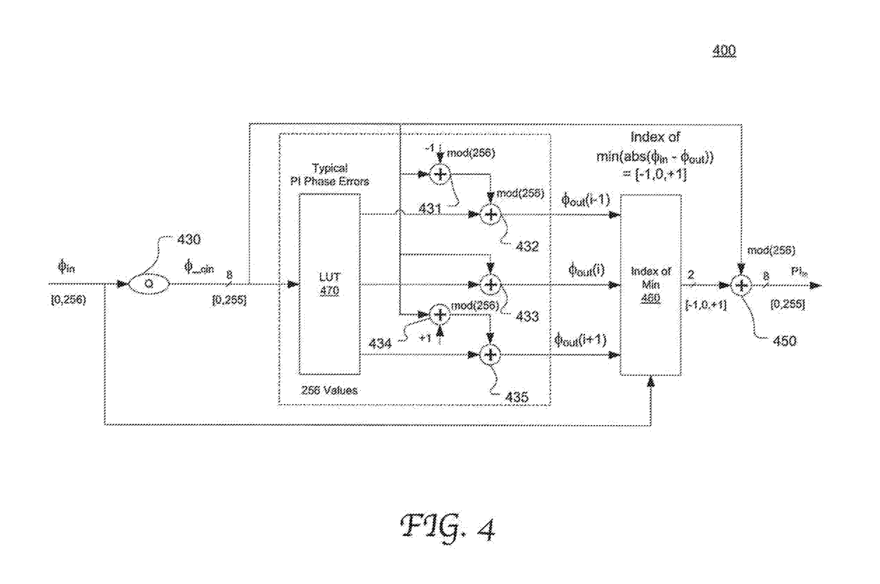

FIG. 4 illustrates the configuration of exemplary calibration logic 400 having an LUT 470 in accordance with another embodiment of the present disclosure. Different from the embodiment illustrated in FIG. 3, the lookup table (LUT) 470 is preloaded with 256 values of typical PI phase errors for all PIᵢₙ values. The errors are due to the linear or octagonal approximations or other impairments. Thus, the size of the LUT word width is reduced by storing the expected PI phase errors of a typical phase interpolator for all possible PIᵢₙ (256 values), rather than the expected PI output phases as in FIG. 3. In addition, there are 5 adders 431-435 used to reconstruct the expected PI phases from the expected PI phase errors once the predetermined number of candidates are selected. All the adder operations are modulo 256.

During operation, upon receiving the quantized input (ϕ_{—qin}) from the quantizer 430, the LUT 470 selects 3 (or any other suitable number of) preloaded PI errors, which respectively correspond to the quantized input, ϕ_{—qin}, and ϕ_{—qin-1} and ϕ_{—qin+1}, where one is the PI error for PI input of ϕ_qᵢₙ, and the other ones are the PI phase error for inputs ϕ_{—qin-1} and ϕ_{—qin+1}. The 3 values output from the LUT are summed with −1, 0, +1 respectively to obtain the 3 expected PI phases when selecting the nominal PIᵢₙ, (PIᵢₙ₋₁) and (PIₙ₊₁), was obtained in the embodiment shown in FIG. 3. The selection logic 460 then identifies the index (−1, 0 or +1) of the expected PI phase that results in the minimum difference from the desired input phase (ϕᵢₙ).

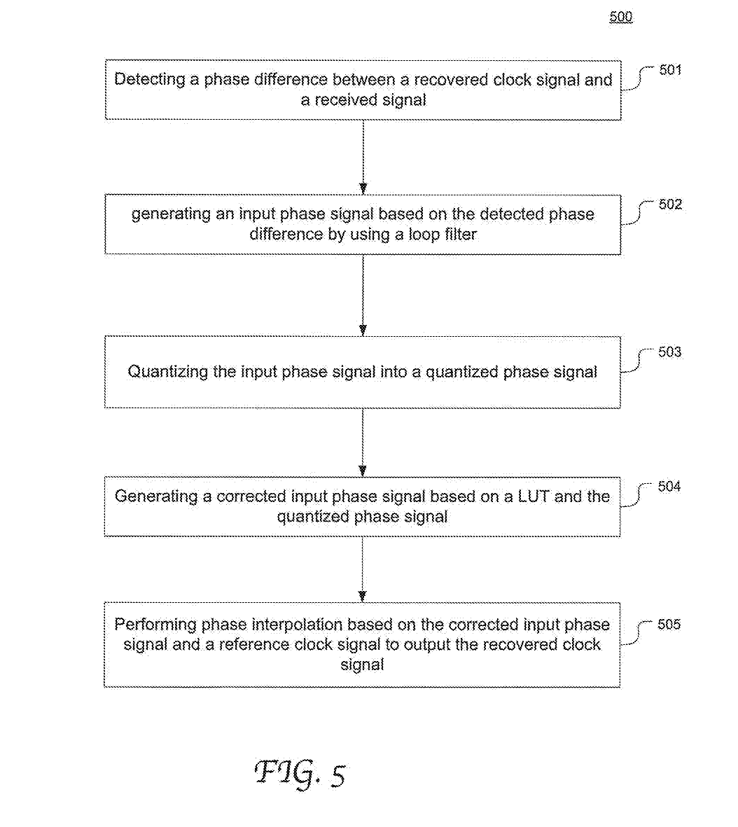

FIG. 5 illustrates an exemplary process 500 of timing recovery including calibration of phase interpolation input in accordance with an embodiment of the present disclosure. Process 500 may be performed by a timing recovery loop, e.g., 200 in FIG. 2. At 501, a phase difference between a recovered clock signal and a received digital signal is detected, e.g., by a phase detector. At 502, an input phase signal is generated based on the detected phase difference by using a loop filter. This input phase signal represents the desired phase input to the phase interpolator and typically has a higher bit width (for instance 30 bits) than the resolution of the phase interpolator (for instance 8 bits).

At 503, the input phase signal is quantized to a quantized input signal as required by the input of the phase interpolator, for instance 8 bits. According to the present disclosure, at 504, a corrected input phase signal is generated based on an LUT and the quantized input signal, as described in greater detail with reference to FIGS. 3 and 4. At 505, phase interpolation is performed based on the corrected input phase signal and a reference clock signal to generate a recovered clock signal. The recovered clock signal is then fed back to the phase detector.

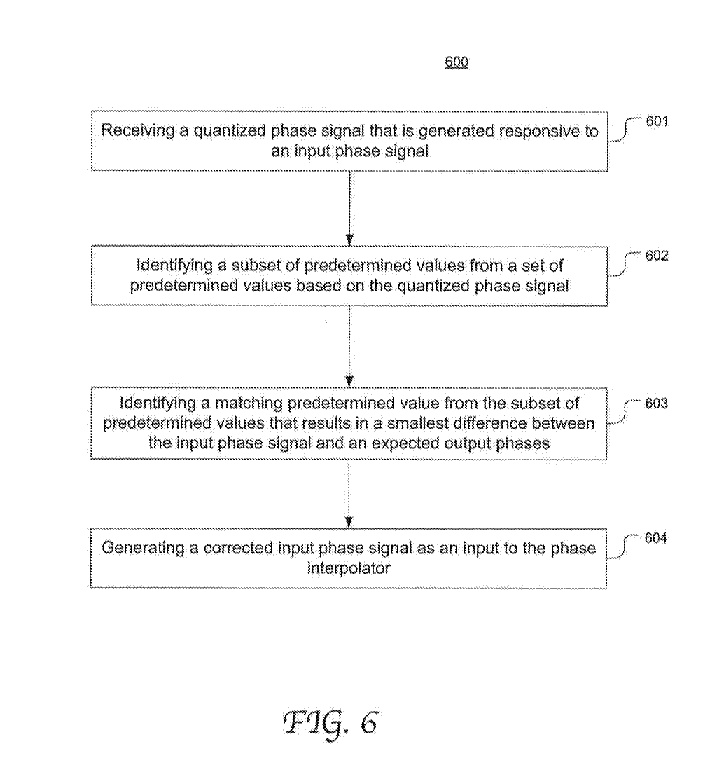

FIG. 6 illustrates an exemplary process 600 of calibrating phase interpolation input in accordance with an embodiment of the present disclosure. Process 600 may be performed calibration logic for a phase interpolator, e.g., 300 in FIG. 3 or 400 in FIG. 4. At 601, a quantized phase signal is received at the calibration logic, which is generated responsive to an input phase signal having a different bit width than the resolution of the phase interpolator. The input phase signal represents a desired phase shift to be achieved by the phase interpolator.

At 602, responsive to the quantized phase signal, a subset of predetermined values are identified from a set of predetermined values. As described above, the predetermined values may correspond to expected PI outputs (as in the illustrated embodiment of FIG. 3) or expected PI errors (as in the illustrated embedment of FIG. 4). However, it will be appreciated that any other type of expected and predetermined values or other information related to phase interpolation may also be used without departing from the scope of the present disclosure.

For example, the set of predetermined values correspond to a full set of phase positions in the phase constellation as implemented by the phase interpolator, and the subset includes 3 expected PI outputs that are closest to the quantized phase signal. At 603, the predetermined values in the subset ate respectively compared with the input phase signal to identify a matching predetermined value in the subset. For example, the matching predetermined value may correspond to the one that is closest to the input phase signal without being quantized.

At 604, a corrected input phase signal is generated and supplied to the input of the phase interpolator. For example, in the embodiments that the LUT stores the expected PI outputs, the corrected input phase signal may be the same as the matching predetermined value. In the embodiments that the LUT stores the expected PI errors, an expected PI output may be derived from the matching predetermined values and the quantized input signal and then supplied to the phase interpolator as the corrected input phase signal.

Although certain preferred embodiments and methods have been disclosed herein, it will be apparent from the foregoing disclosure to those skilled in the art that variations and modifications of such embodiments and methods maybe made without departing from the spirit and scope of the invention. It is intended that the invention shall be limited only to the extent required by the appended claims and the rules and principles of applicable law.

1. A method of signal processing, said method comprising:
receiving an input phase signal representing a first phase;
quantizing said input phase signal into a quantized phase signal;
based on said quantized phase signal, selecting a subset of predetermined values from a set of predetermined values, wherein said set of predetermined values comprise expected output phase values of a phase interpolator;
identifying a matching predetermined value from said subset of predetermined values;
generating a calibrated input phase signal based on said matching predetermined value; and
sending said calibrated input phase signal to an input of said phase interpolator to performing phase interpolation.

2. The method of claim 1, wherein further said calibrated input phase signal represents a second phase equal to said matching predetermined value.

3. (canceled)

4. The method of claim 1, wherein said set of predetermined values are determining by using a simulation process.

5. The method of claim 1, wherein said selecting said subset of predetermined values comprises selecting a predetermined number of closest values with reference to said quantized phase signal from said set of predetermined values.

6. The method of claim 1, wherein said identifying comprises comparing said input phase signal to each of said subset of predetermined values to derive a difference thereof, and wherein further said matching predetermined value results in a smallest difference among said subset of predetermined values.

7. The method of claim 1, further comprising:
detecting a phase difference between a recovered clock signal and a received signal; and
supplying said phase difference to a loop filter to generate said input phase signal, and
wherein said performing phase interpolation is further based on a reference clock signal and results in said recovered clock signal.

8. The method of claim 1, wherein said set of predetermined values are preloaded in a Look-Up Table (LUT), and wherein further said selecting comprises supplying said quantized phase signal to said LUT.

9. A device comprising:
a quantizer configured to generate a quantized phase signal responsive to an input phase signal;
a phase interpolator; and
calibration logic coupled to said quantizer and said phase interpolator and configured to output a corrected input phase signal to said phase interpolator responsive to said quantized phase signal, wherein said calibration logic comprises:
a Look-Up Table (LUT) storing a set of predetermined values, wherein said set of predetermined values comprise expected differences between quantized phase signals and expected output phase values output of said phase interpolator; and
first logic configured to:
identify a matching predetermined value from said set of predetermined values based on said input phase signal; and
generate said corrected input phase signal based on said matching predetermined value; and
sending said corrected input phase signal to an input of said phase interpolator.

10. The device of claim 9, wherein said LUT is further configured to output a subset of predetermined values selected from said set of predetermined values responsive to said quantized phase signal.

11. The device of claim 10, wherein said subset of predetermine values correspond to a predetermined number of closest values with reference to said quantized phase signal.

12. The device of claim 11, wherein said first logic is configured to determine a difference between each of said subset of predetermine values and said input phase signal, and wherein said matching predetermined value results in a smallest difference from said input phase signal among said subset of predetermined values.

13. (canceled)

14. The device of claim 10, wherein said corrected input phase signal represents a sum of said matching predetermined value and said quantized phase signal.

15. The device of claim 9 further comprising:
a phase detector configured to output a detected phase difference between a received signal and a recovered clock signal; and
a loop filter coupled to said phase detector and configured to output said input phase signal responsive to said detected phase difference,
and wherein said phase interpolator is configured to output said recovered clock signal responsive to said corrected input phase signal and a reference clock signal.

16. A device comprising;
a phase detector;
a loop filter coupled to said phase detector and configured to output an input phase signal;
a phase interpolator; and
calibration logic coupled to said phase interpolator and configured to output a corrected input phase signal to said phase interpolator responsive to said input phase signal, wherein said calibration logic comprises:
a Look-Up Table (LUT) storing a set of predetermined values, wherein said set of predetermined values comprise expected output phase values of said phase interpolator; and
first logic configured to:
identify a matching predetermined value from said set of predetermined values based on said input phase signal;
generate said corrected input phase signal based on said matching predetermined value; and
send said corrected input phase signal to an input of said phase interpolator.

17. The device of claim 16 further comprising a quantizer configured to generate a quantized phase signal based on said input phase signal and supply said quantized phase signal to said calibration logic.

18. The device of claim 17, wherein said LUT is further configured to output a subset of predetermined values selected from said set of predetermined values responsive to said quantized phase signal, and wherein said first logic is configured to determine a difference between each of said subset of predetermine values and said input phase signal, and wherein said matching predetermined value results in a smallest difference from said input phase signal among said subset of predetermined values.

19. The device of claim 16, wherein said set of predetermined values comprise expected output phase values of said phase interpolator, and wherein further said corrected input phase signal represents a phase equal to said matching predetermined value.

20. The device of claim 17, wherein said set of predetermined values comprise expected differences between quantized phase signals and expected output phase values from said phase interpolator, and wherein further said corrected input phase signal represents a sum of said matching predetermined value and said quantized phase signal.
